(19) United States
(12) Patent Application Publication
(10) Pub. No.: US 2025/0235948 A1
(43) Pub. Date: Jul. 24, 2025

(54) FASTENING METHOD

(71) Applicant: Hilti Aktiengesellschaft, Schaan (LI)

(72) Inventors: Eric SCHULTE SUEDHOFF, Feldkirch (AT); Uwe POPP, Widnau (CH); Patrick GRAD, Oberterzen (CH); Stefan WOLFSGRUBER, Pettenbach (AT); Philipp DÖRNER, Thalheim (AT)

(21) Appl. No.: 18/699,504

(22) PCT Filed: Nov. 17, 2022
(86) PCT No.: PCT/EP2022/082239

§ 371 Date: Apr. 8, 2024

(30) Foreign Application Priority Data
Nov. 30, 2021 (EP) 21211284.1

(51) Int. Cl. B23K 9/20; B23K 9/16; B23K 101/34

(52) U.S. Cl. CPC B23K 9/202; B23K 9/16; B23K 2101/34

(57) ABSTRACT

A welding device is provided for welding a welding stud to a substrate along a welding axis in a welding direction, the welding device comprising a shielding element with an end face which points in the welding direction and which projects beyond the rest of the welding device in the welding direction, wherein the end face has an end face diameter transversely with respect to the welding direction, furthermore comprising a holding device for holding the welding stud within the shielding element during a welding operation, wherein the holding device has a stud receptacle with an inner diameter, wherein the end face diameter of the end face amounts to at most 3 times the inner diameter.

### TECHNICAL FIELD

The invention relates generally to a device and to a method for fastening a stud to a substrate and also to such a stud.

### PRIOR ART

There are numerous known devices and methods by which various studs are fastened to a substrate in different applications. For example, a stud is brought into contact with the substrate and an electrical current is applied to it. As soon as the electrical current flows between the stud and the substrate, the stud is lifted off the substrate to form an arc. The energy that is released causes the material of the stud and of the substrate to be partially liquefied. The electrical current is then switched off and the stud is immersed into the liquefied material while this material cools down and becomes solid. The stud is then connected to the substrate in an integrally bonded manner.

In order to provide the necessary energy for liquefying the material of the stud and of the substrate in a sufficiently short time, there are known devices that generate an electrical current of a very high current intensity and use a correspondingly rated electrical cable to feed it to the stud. To avoid oxidizing of the liquefied material, it is known to surround the area of contact between the stud and the substrate with an inert gas.

In the case of applications in building construction or shipbuilding, for example, studs of various sizes with a thread to which an item is screwed are used in order to fasten the item to the substrate. Some parameters of the fastening method, such as for example the duration and electrical power of the electrical current, are to be set by a user on the device and are to be adapted to the stud that is used. The user finally assesses the quality of the connection between the stud and the substrate by means of a visual inspection. Therefore, the quality of the connection also depends on the experience and capabilities of the user.

In the case that the substrate has a surface layer, such as for example a coating, a corrosion protection or a dirt layer, this surface layer is customarily ground over a large area before fastening the stud. After fastening the stud, the ground region is cleaned and/or provided with a new coating or corrosion protection layer, which is time-consuming.

### SUMMARY OF THE INVENTION

The object of the invention is to provide a device and/or a method with which fastening of a stud to a substrate is made easier and/or improved.

Said object is achieved with a welding device for welding a welding stud to a substrate along a welding axis in a welding direction, comprising a shielding element with an end face which points in the welding direction and which projects beyond the rest of the welding device in the welding direction, wherein the end face has an end face diameter transversely with respect to the welding direction, furthermore comprising a holding device for holding the welding stud within the shielding element during a welding operation, wherein the holding device has a stud receptacle with an inner diameter, wherein the end face diameter of the end face amounts to at most 3 times the inner diameter. The welding device is preferably formed as a welding gun. The end face diameter of the end face is preferably at most 2 times the inner diameter, particularly preferably at most 1.5 times the inner diameter. Owing to the small dimensions of the end face, it is ensured even in the case of a coated substrate that the end face lies on the substrate material that is to be welded, and not on the coating.

A preferred embodiment is characterized in that the shielding element has an outer diameter greater than the end face diameter.

A further preferred embodiment is characterized in that the shielding element has an inert gas outlet which, with respect to the welding axis, leads radially outward through the shielding element into the surroundings. A spacing of a mouth of the inert gas outlet to the welding axis is preferably greater than the end face diameter.

A preferred embodiment is characterized in that the end face annularly surrounds the welding axis. A further preferred embodiment is characterized in that the end face or an outer periphery of the shielding element is circular.

The object is likewise achieved with a method for fastening a stud to a substrate having a surface layer, comprising the following steps:
providing a stud which has a stud diameter at an end side,
creating a recess in the substrate by removing, in particular machining, the surface layer in a defined surface region having a surface diameter, wherein the surface diameter is greater than the stud diameter,
liquefying the end side and/or the substrate in the recess,
allowing the end side or the substrate to solidify in the recess,
contacting the end side with the substrate in the recess during the solidification, and
arranging a shielding element between the surface layer surrounding the recess and the stud during the liquefaction.

The shielding element preferably has an end face with an end face diameter smaller than the surface diameter. A further preferred embodiment is characterized in that the recess is a blind hole.

### EMBODIMENTS OF THE INVENTION

The invention will be explained in more detail below on the basis of exemplary embodiments with reference to the drawings. In the drawings:

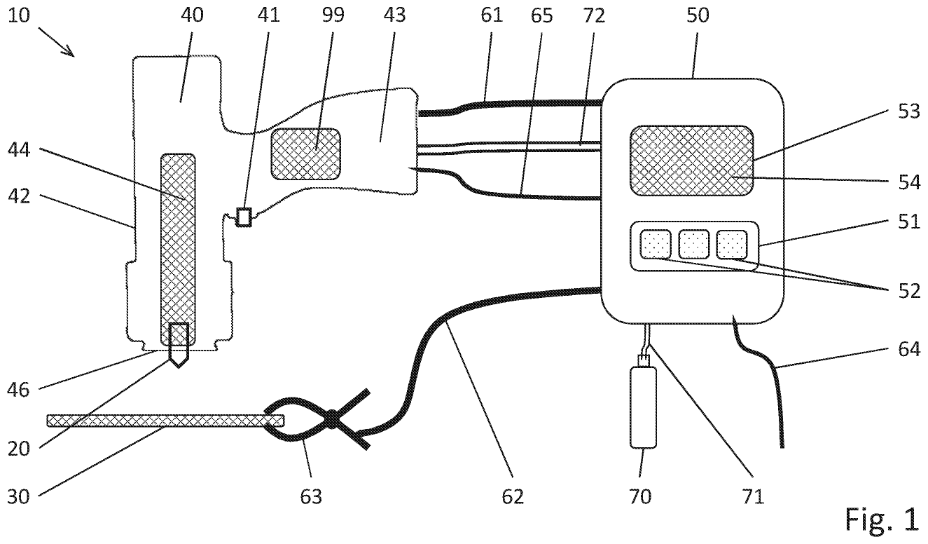

FIG. 1 schematically shows a welding device and

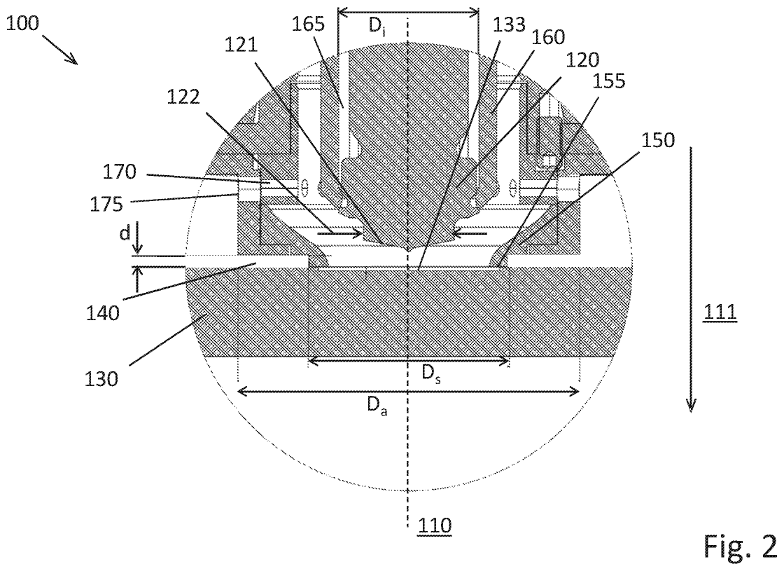

FIG. 2 shows a detail of a welding device in a longitudinal sectional view.

In FIG. 1, a welding device 10 for welding a welding stud 20 to a substrate 30 is schematically shown. A material of the welding stud 20 and a material of the substrate 30 are electrically conductive, in particular metallic. The welding device 10 comprises a welding gun 40 with a trigger switch 41, formed as a pushbutton switch, a welding unit 50, a first electrical cable 61, a second electrical cable 62 with a connection terminal 63, an electrical supply cable 64, formed for example as a power cable, an electrical communication line 65, a gas reservoir 70, formed as a gas cylinder, a tubular gas supply line 71 and a gas hose 72.

The first cable 61 serves for supplying the welding stud 20 with electrical current through the welding unit 50. The second cable 62 serves for electrically connecting the substrate 30 to the welding unit 50 when the connection terminal 63 is clamped to the substrate 30. When the welding stud 20 comes into contact with the substrate 30, a circuit closes, so that welding current, for example in the form of direct current or alternating current, can be applied to the welding stud 20 by the welding unit 50. For this purpose, the welding gun 40 comprises a welding-current contact element that is not shown in FIG. 1. The welding unit 50 comprises a device that is not shown for converting electrical current from the supply cable 64 into welding current, which device comprises for example an electrical capacitor, a thyristor, a bipolar transistor with an isolated gate electrode or other components from power electronics, and also an associated control unit with a microprocessor, in order to provide the welding current at the desired voltage and current intensity.

The gas supply line 71 and the gas hose 72 serve for supplying a contact region between the welding stud 20 and the substrate 30 with an inert gas from the gas reservoir 70, in order to protect the contact region from oxidation due to oxygen from a surrounding area during a welding operation. For controlling a gas flow to the contact region, the gas reservoir 70, the gas supply line 71, the welding unit 50, the gas hose 72 or the welding gun 40 comprises a valve (not shown), in particular a controllable valve.

The welding unit 50 has an input device 51 having actuating elements 52, and an output device 53 having a visual display element 54 and a wireless transmission unit. The input device 51 serves for the input of parameters of a welding method to be carried out with the welding device 10, for example the electrical voltage, current intensity, power and time duration of the welding current, position and speed of the stud and so on, by a user of the welding device 10. The output device 53 serves to output information to the user, for example information about parameters of the welding method, information about detected emissions of the welding method or other variables, information about a quality of the welding operation, information about measures for improving the welding operation, information about detected characteristics of the welding stud, or information derived from the aforementioned variables, and/or recommendations or instructions for cleaning and/or maintaining the welding device 10, in particular the welding gun 40.

The communication line 65 serves for communication between the welding gun 40, in particular a control device (not shown in FIG. 1) of the welding gun 40, and the welding unit 50, in particular the control unit and/or the input device 51 and/or the output device 53. By means of this communication, for example, an exchange of information about the parameters of a welding operation is accomplished, in order for example to achieve or facilitate a synchronization of the welding current with a movement of the welding stud 20. In exemplary embodiments that are not shown, the communication between the welding gun and the welding unit takes place wirelessly, by radio or by means of the first electrical cable, which carries the welding current.

The welding gun 40 has a housing 42 with a mouth 46, from which housing a handle 43 with the trigger switch 41 protrudes. The welding gun 40 also has a stud holder 44. on which the welding stud 20 is held during a welding operation. For this purpose, the stud holder comprises for example two, three, four or more resilient arms (not shown in detail), between which the welding stud 20 is inserted and held by means of a clamping fit. For applying a welding current to the welding stud 20, the welding gun 40 also has a welding-current contact element, which is integrated in the stud holder 44, for example in the form of one or more of the resilient arms.

The welding gun 40 also has a control device 99 for controlling the various components and devices of the welding gun and of the welding unit 50. The control device 99 is intended for controlling one or more parameters of the welding operation. For this purpose. the control device 99 comprises various electronic components, for example one or more microprocessors, one or more temporary or permanent data memories, and the like.

The welding gun 40 also has a stud lifting device, which is formed as a first lifting magnet and acts on the stud holder 44 with a force rearwardly away from the mouth 46 (upwardly in FIG. 1) when the stud lifting device is activated. Via a signal line (not shown), the control device 99 communicates with the stud lifting device in order to control the stud lifting device, in particular to activate and deactivate it.

The welding gun 40 also has a stud immersing device, formed as a spring element or as a second lifting magnet, which acts on the stud holder 44 with a force forwardly toward the mouth 46 (downwardly in FIG. 1) when the stud immersing device is activated. Via a signal line (not shown), the control device 99 communicates with the stud immersing device in order to control the stud immersing device, in particular to activate and deactivate it. If the stud immersing device is formed as a spring element, this spring element is preferably tensioned when the stud holder is moved rearward by the stud lifting device, so that the spring element moves the stud holder forward as soon as the stud lifting device is deactivated.

In a welding method with the welding device 10, first the substrate 30 and the stud 20 are provided. In a further step, information, for example about desired parameters of the following welding operation, is input by a user via the input device. In a further step, a welding current between the welding stud 20 and the substrate 30 is applied to the welding stud 20 by the welding unit 50 by means of the first cable 61 and the second cable 62. In a further step, the welding stud 20 is lifted off the substrate by means of the stud lifting device while maintaining the welding current flowing between the welding stud 20 and the substrate 30, with an arc being formed between the welding stud 20 and the substrate 30. In particular on account of the heat generated by the arc, a material of the welding stud 20 and/or of the substrate 30 is then partially liquefied. In a further step, the welding stud 20 is immersed by means of the stud immersing device into the liquefied material of the welding stud 20 or of the substrate 30. The liquefied material of the welding stud 20 or of the substrate 30 then solidifies, so that the welding stud 20 is connected to the substrate 30 in an integrally bonded manner.

FIG. 2 illustrates a welding device 100 in the form of a welding gun for welding a welding stud 120 to a substrate 130 along a welding axis 110 in a welding direction 111 during a welding operation. The substrate 130 has a surface layer 140 which comprises for example one or more protective layers, in particular against corrosion, an oxide layer, in particular metal oxide layer, or a dirt layer. At an end side 121 of the welding stud 120, the welding stud has a stud diameter 122 of for example 8 mm, the end side 121 being convex and having the form of a flat cone lateral surface and/or having a circular cross-sectional area. In a defined circular surface region having a surface diameter, the substrate 130 has a recess 133 in the form of a blind hole having a blind hole depth. The surface diameter is for example 20 mm and is greater than the stud diameter 122.

The recess 133 has a constant depth at least in a radially outer edge region, this depth being equal to a thickness d of the surface layer 140. To create the recess 133, the surface layer 140 has been removed in the defined surface region by having been machined by drilling by means of a drilling tool. The drilling tool is preferably a step drill which has a peripheral step whose axial distance from a drilling tip of the step drill is equal to the desired blind hole depth.

The welding device 100 has a shielding element 150 with an end face 155 which points in the welding direction 111 and which projects beyond the rest of the welding device in the welding direction 111. The end face 155 is circular and annularly surrounds the welding axis 110. Transversely with respect to the welding direction 111, the interface 155 has an end face diameter Dₛ.

The welding device 100 furthermore has a holding device 160, which holds the welding stud 120 within the shielding element 150 during a welding operation. The holding device 160 has a stud receptacle 165 with an inner diameter Dᵢ. The end face diameter Dₛ of the end face 155 is approximately 1.4 times the inner diameter Dᵢ. By contrast, an outer diameter Dₐ of the shielding element 150 is greater than the end face diameter Dₛ.

The shielding element 150 has an inert gas outlet 170 which, with respect to the welding axis 110, leads radially outward through the shielding element 150 into the surroundings. A spacing of a mouth 175 of the inert gas outlet 170 to the welding axis 110 is greater than the end face diameter Dₛ. In the case of a circular outer periphery of the shielding element 150, said spacing is under some circumstances half of the outer diameter of the shielding element 150.

During the welding operation, in particular during the liquefaction of the material of the welding stud 120 and of the substrate 130, the shielding element 150 is arranged between the surface layer 140 surrounding the recess and the welding stud 120. In this way, the surface layer 140 is shielded from the welding location and is protected against instances of combustion which, owing to the formation of combustion gases, could impair the weld quality. Furthermore, the end face 155 lies on the substrate material that is to be welded, and not on the surface layer 140. In this way, even in the case of a surface layer 140 of non-uniform thickness, it is ensured that the spacing of the welding stud 120 to the substrate 130 at the start of the welding operation does not depend on a thickness of the surface layer 140.

The invention has been described on the basis of examples of a device for fastening a first item to a second item and a production method for such a device. The features of the described embodiments can also be combined here as desired with one another within a single fastening device or a single production method. It should be noted that the device according to the invention and the method according to the invention are also suitable for other purposes.

1. A welding device for welding a welding stud to a substrate along a welding axis in a welding direction, comprising a shielding element with an end face which points in the welding direction and which projects beyond a rest of the welding device in the welding direction, wherein the end face has an end face diameter transversely with respect to the welding direction, furthermore comprising a holding device for holding the welding stud within the shielding element during a welding operation, wherein the holding device has a stud receptacle with an inner diameter, wherein the end face diameter of the end face amounts to at most 3 times the inner diameter.

2. The welding device as claimed in claim 1, wherein the end face diameter of the end face amounts to at most 2 times the inner diameter.

3. The welding device as claimed in claim 2, wherein the end face diameter of the end face amounts to at most 1.5 times the inner diameter.

4. The welding device as claimed in claim 1, wherein the shielding element has an outer diameter greater than the end face diameter.

5. The welding device as claimed in claim 1, wherein the shielding element has an inert gas outlet which, with respect to the welding axis, leads radially outward through the shielding element into the surroundings.

6. The welding device as claimed in claim 5, wherein a spacing of a mouth of the inert gas outlet to the welding axis is greater than the end face diameter.

7. The welding device as claimed in claim 1, wherein the end face annularly surrounds the welding axis.

8. The welding device as claimed in claim 1, wherein the end face is circular.

9. The welding device as claimed in claim 1, wherein an outer periphery of the shielding element is circular.

10. A method for fastening a stud to a substrate having a surface layer, the method comprising:
a) providing a stud which has a stud diameter at an end side,
b) creating a recess in the substrate by removing the surface layer in a defined surface region having a surface diameter, wherein the surface diameter is greater than the stud diameter,
c) liquefying the end side and/or the substrate in the recess,
d) allowing the end side or the substrate to solidify in the recess,
e) contacting the end side with the substrate in the recess during the solidification, and
f) arranging a shielding element between the surface layer surrounding the recess and the stud during the liquefaction.

11. The method as claimed in claim 10, in which the shielding element has an end face with an end face diameter smaller than the surface diameter.

12. The method as claimed in claim 10, wherein the recess is a blind hole.

13. The welding device of claim 1, wherein the welding device is a welding gun.

14. The welding device as claimed in claim 2, wherein the shielding element has an outer diameter greater than the end face diameter.

15. The welding device as claimed in claim 2, wherein the shielding element has an inert gas outlet which, with respect to the welding axis, leads radially outward through the shielding element into the surroundings.

16. The welding device as claimed in claim 2, wherein a spacing of a mouth of the inert gas outlet to the welding axis is greater than the end face diameter.

17. The welding device as claimed in claim 2, wherein the end face annularly surrounds the welding axis.

18. The welding device as claimed in claim 2, wherein the end face is circular.

19. The welding device as claimed in claim 2, wherein an outer periphery of the shielding element is circular.

20. The method of claim 10, wherein b) comprises creating a recess in the substrate by machining the surface layer in the defined surface region.
